(19) United States
(12) Patent Application Publication
(10) Pub. No.: US 2023/0028384 A1
(43) Pub. Date: Jan. 26, 2023

(54) UNIT FOR MAKING BEVERAGES BY BREWING

(71) Applicant: UNIC, Carros (FR)

(72) Inventors: Jean-Pierre LEVI, Nice (FR); Mario LEVI, Nice (FR)

(21) Appl. No.: 17/783,696

(22) PCT Filed: Nov. 26, 2020
(86) PCT No.: PCT/EP2020/083487

§ 371 Date: Jun. 9, 2022

(30) Foreign Application Priority Data
Dec. 13, 2019 (FR) FR1914328

(51) Int. Cl. A47J 31/44; A47J 31/36; A47J 31/46; A47J 31/52

(52) U.S. Cl. CPC A47J 31/4403; A47J 31/3614; A47J 31/469; A47J 31/52

(57) ABSTRACT

A unit for the preparation of beverages by brewing a dose of a product to be brewed, including at least one brewing chamber provided with a receptacle for the dose and with an injection circuit for injecting water into the receptacle, the brewing chamber being topped by a movable tray provided with an orifice adapted to be selectively placed opposite a mouth of the receptacle of the brewing chamber, so as to open or close the brewing chamber depending on the position of the orifice, the brewing chamber comprising a sealing element configured to ensure a sealed contact between a peripheral area of the mouth of the brewing chamber and a lower face of the tray.

### TECHNICAL FIELD

The present invention relates to the field of units for preparing beverages by brewing. It finds a particularly advantageous application in the field of coffee machines, for the production of coffee-based beverages from ground coffee. However, this does not exclude the manufacture of other types of beverages, in particular those made exclusively from ground coffee, or made from other materials to be brewed.

### PRIOR ART

Machines for making hot beverages from the material to be brewed, most often ground coffee, conventionally comprise a brewing chamber throughout which water is circulated to produce, at the outlet, a brewed beverage. In this configuration, the machine comprises a boiler, a water injection circuit (implementing a quite high hot water pressure, via a pump) and a brewing chamber into which the hot water injection circuit opens.

A first type of machine has a manual operation to the extent that it is up to the user to carry out the loading of a dose of material to be brewed, the closure of the brewing chamber, the flow of water throughout the latter to produce the beverage, and, finally, the opening of the brewing chamber to evacuate the brewed material. In general, this is performed by means of a cup-holder device mounted on an easy-to-handle grip.

More automated machines have also been suggested, as is the case in the patent publication WO 01/54 550 A1. In this case, corresponding to FIGS. 1 and 2, the opening and closure phases of a brewing chamber are performed via a rotating tray surmounting the brewing chamber, and preferably a plurality of brewing chambers, so that the machine could work in parallel on several chambers. An orifice crossing the tray could be positioned opposite the mouth of one of the brewing chambers so as to carry out the intake of material to be brewed or else the evacuation of brewed material.

While performing these operations, the flow of water could occur in another brewing chamber to make a beverage in masked time.

In general, this machine is satisfactory thanks to its high efficiency. Nevertheless, it deserves good management of the movability of the tray. Indeed, the movement should be carried out while keeping a sealed connection with respect to the mouths of the brewing chambers, thanks to efficient sealing means and/or a good positioning of the orifice of the tray opposite the mouth of one of the chambers.

The patent document U.S. Pat. No. 5,007,333 A discloses a machine for preparing brewed beverages with arrangements for sealing the brewing chamber. The patent document US2006/144243 A1 presents a solution of a brewing unit with a tray movable in rotation surmounting the brewing chambers.

An object of the present invention is to provide a unit of beverage production from a material to be brewed having a movable tray whose cooperation with the brewing chambers is improved.

The other objects, features and advantages of the present invention will become apparent upon examining the following description and the appended drawings. It should be understood that other advantages could be incorporated.

### SUMMARY

To achieve this objective, according to one embodiment, a unit is provided for the preparation of beverages by brewing a dose of a product to be brewed, including at least one brewing chamber provided with a receptacle for the dose and with a circuit for injecting water into the receptacle, the brewing chamber being topped by a movable tray provided with an orifice adapted to be selectively placed opposite a mouth of the receptacle of the brewing chamber, so as to open or close the brewing chamber depending on the position of the orifice, the brewing chamber comprising a sealing element configured to ensure a sealed contact between a peripheral area of the mouth of the brewing chamber and a lower face of the tray.

According to a distinct first aspect, the sealing element comprises:
a first gasket having a first surface bearing on the lower face of the tray;
a second gasket having a first surface bearing on the peripheral area;
a support comprising an upper face bearing on a second surface of the first gasket and a lower face bearing on a second surface of the second gasket.

Thus, the sealing element has a complex structure taking advantage of a significant degree of deformation to accommodate the movements of the tray and the pressure of the water injected into the brewing chamber. This is also the way to accurately adapt the gasket parameters (shape and/or material) to the stresses of each portion. In particular, the planar contact on the lower face of the tray is preferably ensured by a planar surface of the first gasket. Still without limitation, the second gasket may be an O-ring to have a capacity for deformation and/or displacement relative to the peripheral area. The support, preferably made of a material more rigid than that of the gaskets, such as steel, another metal, or a non-elastomeric polymer, ensures the interface between the gaskets.

According to another distinct aspect, a unit is provided for preparing beverages by brewing of a dose of a product to be brewed, including at least one brewing chamber provided with a receptacle for the dose and with a circuit for injecting water into the receptacle, the brewing chamber being topped by a movable tray provided with an orifice adapted to be placed selectively opposite a mouth of the receptacle of the brewing chamber, so as to open or close the brewing chamber depending on the position of the orifice, the brewing chamber comprising a sealing element configured to ensure a sealed contact between a peripheral area of the mouth of the brewing chamber and an lower face of the tray and comprising a control system of the tray configured to drive the tray in rotation and to determine a value reflecting the rotational speed of the tray.

Thanks to this arrangement alternative or complementary to the arrangements relating to the sealing gaskets, the operation of the unit could be finely adapted to the friction conditions of the tray, so that its successive positions are accurate; in particular, this enables the orifice of the tray to be right opposite a chamber mouth, in the open position thereof.

According to one possibility, the water injection path in the brewing chamber induces a water pressure on the sealing element configured to increase bearing of the first gasket on the tray.

Advantageously, the arrangements relating to sealing, and those of speed control of the tray are combined so as to produce a reliable and repeatable movement of the tray.

Another aspect relates to a method for controlling a tray of a unit. According to one possibility, this method comprises an assessment of a discrepancy between the determined value and a set value, and a modification of the control of the tray according to the discrepancy. In particular, the rotation of the tray could be slowed down more or less rapidly in its travel between two positions, in particular between two brewing chambers.

### BRIEF DESCRIPTION OF THE FIGURES

The aims, objects, as well as the features and advantages of the invention will appear better from the detailed description of an embodiment of the latter which is illustrated by the following appended drawings wherein:

FIG. 1 represents a perspective view of a unit according to FIG. 1 of the publication WO 01/54 550 A1.

FIG. 2 represents a sectional view of a unit according to FIG. 2 of publication WO 01/54 550 A1.

FIG. 3 shows an embodiment of the invention, in section at the level of a brewing chamber.

FIG. 4 is a detail of FIG. 3 illustrating making of gasket portions.

FIG. 5A shows a first gasket in perspective.

FIG. 5B shows in perspective a support that could be arranged between two gaskets.

FIG. 5C shows a second gasket in perspective.

FIG. 6 shows a basic relative position between the tray and two chambers.

FIG. 7A illustrates a first dynamic intermediate position in forth way between the basic position and a position of the tray opening a first chamber.

FIG. 7B illustrates a second dynamic intermediate position in forth way between the basic position and a position of the tray opening a first chamber.

FIG. 8 illustrates the position of the tray opening a first chamber.

FIG. 9A illustrates a first dynamic intermediate position in back way between the position of the tray opening a first chamber and the basic position.

FIG. 9B illustrates a second dynamic intermediate position in back way between the position of the tray opening a first chamber and the basic position.

The drawings are provided as examples and do not limit the invention. They consist of schematic representations of principle intended to facilitate understanding of the invention.

### DETAILED DESCRIPTION

Before starting a detailed review of embodiments of the invention, optional features are set out hereinafter which could be used in combination or alternatively:
the first surface 311 of the first gasket 31 is planar;
the second gasket 32 is an O-ring;
the first surface of the second gasket 32 is configured to be applied on the two surfaces of the peripheral area having different orientations;
the upper face of the support 30 includes a groove 301 for mounting the first gasket 31;
the lower face of the support 30 includes an area in the form of a fillet 302;
the brewing chamber 1a, 1b includes, at the mouth, an annular portion 33 set back with respect to the wall of the receptacle 2a, 2b, the setback annular portion 33 receiving the sealing element;
the wall of the receptacle 2a, 2b comprises a cylindrical sleeve 20, the setback annular portion 33 being delimited by an outer face 22 of the sleeve 20.
the injection circuit comprises a water supply circuit 26, said water supply circuit 26 comprising a portion extending along the outer face 22 of the sleeve 20, up to a passage 27 for supplying water into the receptacle 2a, 2b;
the passage 27 comprises an interstitial space between an upper end of the sleeve 20 and the lower face 3 of the tray 4.
the water supply circuit 26 is formed between the outer face 22 of the sleeve 20 and an inner face of a body 24 of the brewing chamber 1a, 1b.
the unit comprises a control system of the tray 4 configured to drive tray 4 in rotation and to determine a value reflecting the rotational speed of tray 4;
the control system is configured to assess a discrepancy between the determined value and a set value, and to modify the control of the tray 4 according to the shift.
the control system is configured to determine a value reflecting the rotational speed of the tray 4 by measuring a time shift between at least two predefined angular positions of the tray 4;
the control system comprises at least one presence sensor 37, 38 and the tray 4 includes at least one area detectable by the sensor 37, 38.

The unit according to the invention comprises one or, preferably, several brewing chamber(s) in which brewing of a product such as ground coffee is carried out.

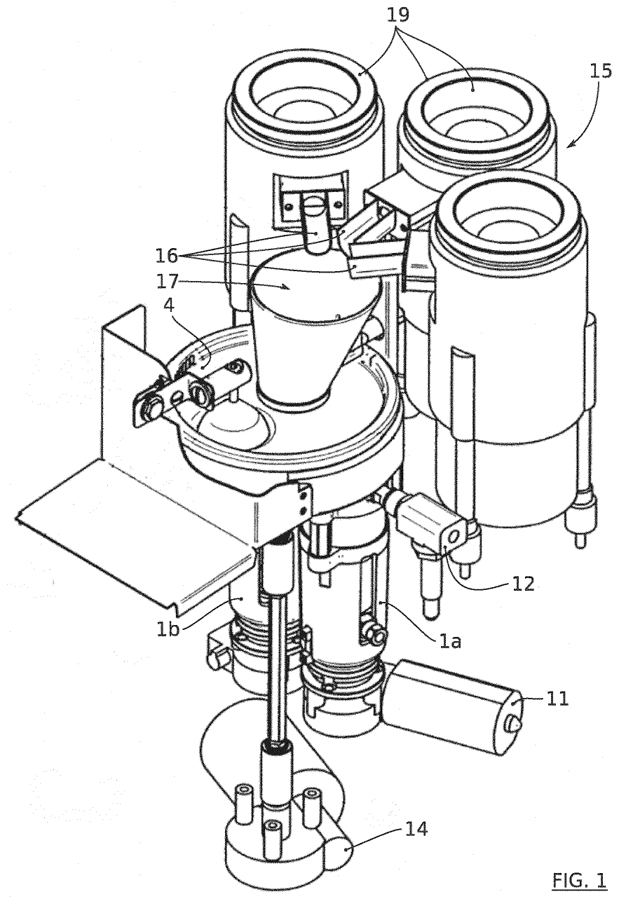

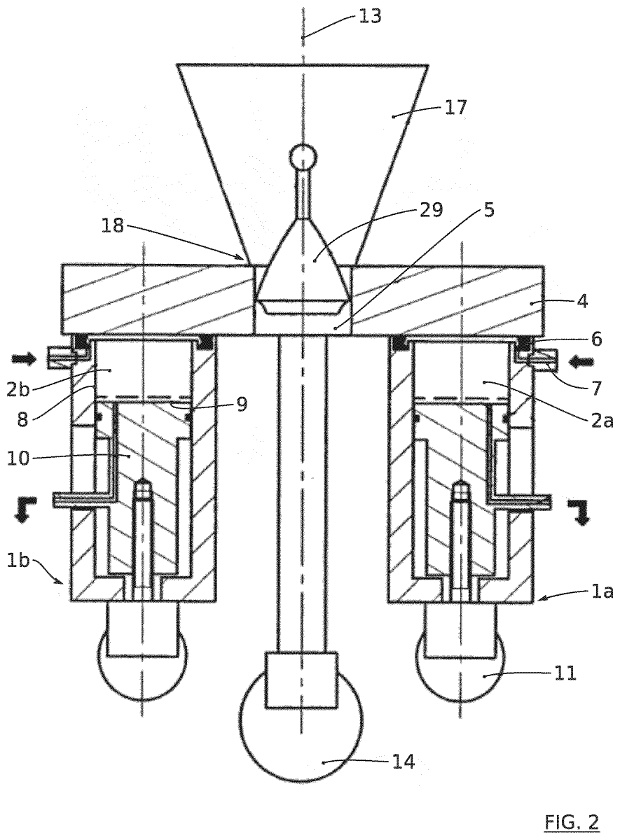

FIGS. 1 and 2 illustrate an example of a unit according to the patent publication WO0154550 A1. Unless stated otherwise in the present description, the components of this unit could be used in the context of the unit of the invention. Consequently, they are described hereinafter in the context of the invention.

FIGS. 1 and 2 show the embodiment with two brewing chambers marked 1a, 1b.

Each of these chambers comprises a receptacle marked 2a, 2b adapted to receive in their internal volume a dose of the product to be brewed. Means for injecting hot water allowing brewing to be carried out are also present in each of the brewing chambers 1a, 1b. A preferred embodiment will be described later on. Preferably, a boiler is installed in the machine so as to supply hot water to the water supply circuit to the chambers 1a, 1b. A pump ensures the pressurisation of this water, for example above 10 bars.

According to the invention, the brewing chambers 1a, 1b are juxtaposed as shown in the case of the two chambers, in FIG. 2.

Moreover, they are topped by a movable tray 4 provided with an orifice 5. Depending on the position of the movable tray 4, the orifice 5 may be positioned opposite one of the brewing chambers 1a, 1b so as to open it. When the orifice 5 is not positioned opposite a brewing chamber 1a, 1b, the latter is closed. FIG. 2 shows the case of two closed brewing chambers 1a, 1b.

It clearly appears that the formation of a unique tray 4 provided with an orifice 5 ensures the opening and closure phases of all brewing chambers 1a, 1b.

In the illustrated preferred embodiment, the tray 4 is movable in rotation according to an axis 13 marked in FIG. 2. However, other embodiments are possible, in particular by conferring translational movability on the tray 4.

According to the prior art of FIGS. 1 and 2, sealing of the closure of the brewing chambers 1a, 1b is ensured by the formation of a gasket 6 between each brewing chamber 1a, 1b and the movable tray 4, for example, an O-ring. However, an advantageous alternative to this O-ring is described later on.

Still in FIG. 2, hot water injection means are shown consisting of water supply circuits 7 having a radial inlet opening into each brewing chamber 1a, 1b.

Upstreams, the water injection circuit may comprise a pump and a system of at least one brewing solenoid valve 12 shown in FIG. 1.

Preferably, the radial injection of hot water avoids having all injection means carried by the tray 4.

Still as a preferred example, FIG. 2 illustrates a circuit for discharging the brewed beverage via an outlet. In this context, the evacuation circuit towards the outlet is formed in a movable plunger 10 forming the lower wall 9 of the receptacle 2a, 2b of each brewing chamber 1a, 1b. Preferably, the movable plunger 10 carries a filter ensuring the passage of the beverage towards the outlet.

The formation of a plunger 10 movable in translation allows varying the internal volume of the receptacle 2a, 2b.

Thus, it is possible to adapt it according to the dose 3 integrated in the receptacle or else according to the desired grind packing. Moreover, the translational movability of the plunger 6 ensures its passage between a position for receiving the dose 3 and a position for ejecting the dose 3 in the orifice 5 when it is used.

After completion of brewing, the ejection of the used dose out of the receptacle 2b is performed by through a full deployment of the plunger 10. The used dose is thus recovered at the level of the movable tray 4 in the orifice 5. Preferably, the orifice 5 has a section whose shape is identical and the dimensions slightly larger than those of the opening of the brewing chambers 1a, 1b. In the example of the different figures, both the brewing chambers 1a, 1b and the orifice 5 have a circular cross-section with a substantially corresponding diameter, within a few millimetres.

Not only does the movable tray 4 contributes to the ejection of the dose out of the brewing chambers 1a, 1 b, but it could also enable the evacuation of the used dose out of the unit. For this purpose, the periphery of the orifice 5 will advantageously have a thickness at least equal to the maximum height of the used dose ejected after brewing.

Moreover, the evacuation of the used dose thus present in the orifice 5 may be carried out by gravity after displacement of the movable tray 4.

Preferably, and as illustrated in the figures, the tray 4 is a disk movable in rotation, in particular in a horizontal plane.

Moreover, the unit preferably comprises two brewing chambers 1a, 1b positioned on the tray 4.

The orifice 5 and the brewing chambers 1a, 1b are placed so that they face (and are centred on) either one of the chambers 1a, 1b upon rotation of the tray 4.

This rotation may be ensured about an axis 13 by means of a motor drive 14 made in a common way, in particular by means of a geared motor and a drive system as represented in FIGS. 1 and 2.

Similarly, the displacement of the movable plunger 10 may be generated by a motor drive 11 with a common design.

In order to ensure full automation of the beverage manufacturing cycle, the unit will preferably comprise a set 15 for supplying the products to be brewed. This set 15 shown in FIG. 1, leads to at least one supply channel 16. Below these channels 16, a funnel 17 could receive the dose of the product to be brewed by gravity.

Moreover, the lower end 18 of the funnel 17 opens at the level of the movable tray 4 as shown in FIG. 2. The funnel 17 shown in the figures has a substantially flared shape at its upper end in comparison with its lower end 18.

However, it should be understood that the invention is not limited to such a configuration and, in particular, a funnel with a constant section over its entire height may be formed.

To ensure loading of the dose into one of the brewing chambers 1a, 1b, the lower end 18 is positioned opposite one of these chambers 1a, 1b, and at the same time, the opening 5 is also placed opposite thereof.

To perform the funnel 17 positioning operation, positioning means are present.

A particular shape of the evacuation means is shown in FIGS. 1 and 2 which illustrate making of a weight 29 mounted on suspension means enabling the introduction and the extraction of the weight 29 in the orifice 5. The weight 29 has a section with the same shape and dimensions slightly smaller than those of the section of the orifice 5. In this manner, the weight 29 is adapted to scrape the walls of the orifice 5 avoiding any persistence of the product to be brewed.

The different steps of operation of the unit applicable to the invention are described hereinafter.

A phase of introducing a dose of the product to be brewed is performed in the brewing chamber 1b at its receptacle 2b. This introduction is possible by positioning the movable tray 4 such that the orifice 5 faces the receptacle 2b.

Moreover, this positioning of the movable tray 4 preferably ensures driving of the funnel 17 which is also positioned opposite the opening of the receptacle 2b.

At this point, the supply set 15 could be set into operation to ensure the transfer of the product to be brewed (such as ground coffee) into the brewing chamber 1b.

As illustrated in FIG. 1, the supply means 15 may include several grinders 19 adapted to grind coffee grains to obtain a grind.

When a dose is introduced in this manner into the brewing chamber 1b, the latter could be closed through another rotation phase of the movable tray 4.

It is then possible to end in the position illustrated in FIG. 2 in which the chamber 1b is closed and the weight 29 brought back to the rest position.

At this point, brewing could be carried out by a radial injection of hot water into the brewing chamber 1b through the circuit 7.

Afterwards, the beverage is recovered in a common manner.

Before starting the brewing phase, the movable plunger 10 could be raised so as to perform packing of the product to be brewed.

Once brewing is completed, it is possible to eject the used dose from the brewing chamber 1b.

In this context, the movable tray 4 is positioned so that the orifice 5 faces the opening of the receptacle 2b of the brewing chamber 1b.

Henceforth, the movable plunger 10 could translate so that the dose is recovered in the orifice 5. A new rotation of the movable tray 4 in the direction opposite to the previous one enables the evacuation of the dose by gravity.

It should be noted that during the completion of these different steps in the brewing chamber 1b, the brewing chamber 1a could also operate independently. This brewing could also continue during the steps of loading the brewing chamber 1b, of ejecting the used dose and of evacuating the used dose.

Similarly, it is possible to perform loading, brewing, ejection and evacuation phases for the brewing chamber 1a while the brewing chamber 1b is operating.

It should be noted that the movements of the movable tray 4 are performed in rotation preferably around a rest position illustrated in FIG. 6. The movable tray 4 is adapted to be rotated around this position in either direction depending on the operations to be performed with respect to either the brewing chamber 1b or the brewing chamber 1a.

It should be understood that this movability of the tray 4 should take place while preserving the sealing of the brewing chamber(s) 1a, 1b covered thereby.

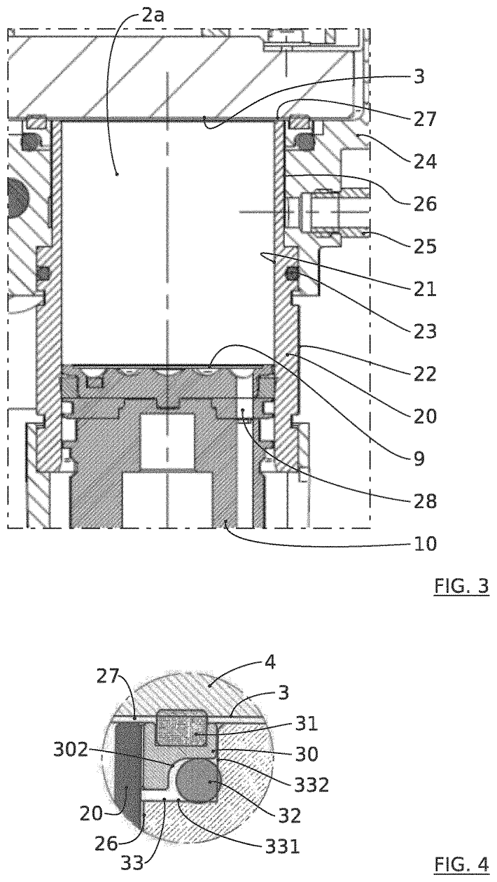

In this context, FIGS. 3 to 5C show an embodiment of the invention ensuring optimised sealing. The sealing element comprises a plurality of components which will be described in detail hereinafter. The sealing element is configured to surround the mouth of the considered receptacle 2a, 2b. In the set-up of FIG. 3, the brewing chamber 1a comprises, at the level of the mouth, a peripheral area with a closed contour, advantageously circular, so as to form a setback annular portion 33 (i.e. at the periphery) of the receptacle 2a. This setback may be formed in a portion of the body 24 of the brewing chamber.

In this embodiment, the wall of the receptacle is at least partly delimited by an inner surface 21 of a cylindrical sleeve 20, whose longitudinal axis extends according to the direction of movability of the plunger 10. For example, this sleeve 20 may be metallic. Advantageously, the space for accommodating the sealing element is located on the opposite face of the sleeve 20. The compartment of the sealing element is then delimited by the setback portion formed in the body 24 and by the wall also called the outer surface 22 of the sleeve 20.

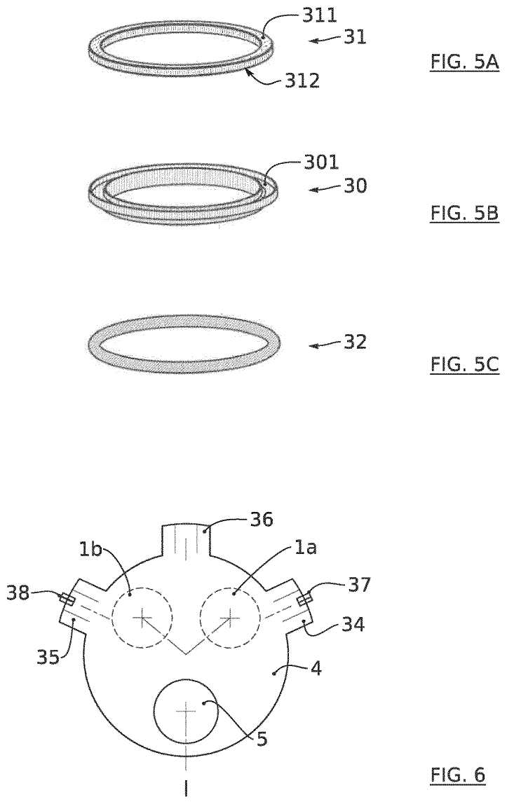

FIG. 4 shows in more detail the components of the sealing element and their cooperation with their environment. A first gasket 31 is applied on the lower face 3 of the tray 4 by a first bearing surface 311, preferably planar, just like the corresponding portion of the lower face 3. By an opposite surface, referenced 312 in FIG. 5A, the first gasket 31 cooperates with a support 30. Advantageously, the support 30 comprises a groove 301, preferably in the form of an annular groove with a closed contour, receiving a lower portion of the first gasket 31.

Preferably, the first gasket 31 is made of a polymer material with a low coefficient of friction. In particular, it may be polytetrafluoroethylene. In this manner, the movability of the tray 4 does not induce high frictional forces relative to this first gasket 31.

Opposite to the first gasket 31 with respect to the support 30, the sealing element comprises a second gasket 32. The latter cooperates with the peripheral area of the brewing chamber, in the area for accommodating the sealing element. Advantageously, the second gasket 32 is an O-ring. It may be made of an elastomeric material. In this case, in general, the modulus of elasticity of the second gasket 32 is preferably strictly higher than that of the first gasket 31 so as to confer on the second gasket 32 a function of accommodating the sealing element with regards to the stresses subjected thereon; in this arrangement, it is possible to select the material of the first gasket 31 that is the most suitable for cooperation thereof with the lower face 3 of the tray 4, while leaving the second gasket 32 with an appropriate elastic deformation capacity.

In the configuration shown in FIG. 4, the gasket 32 cooperates with the peripheral area of the mouth of the brewing chamber at two locations of this area. Indeed, the peripheral area is an annular portion 33 which comprises a first wall directed radially with respect to the longitudinal axis of the brewing chamber, and a second wall, advantageously with a circular section, directed according to this longitudinal axis. At the level of the first wall, a first surface 331 of the peripheral area cooperates with the gasket 32. At the level of the second wall, a second surface 332 of the peripheral area cooperates with the gasket 32. It should be understood that this last gasket thus abuts in two directions, to ensure immobilisation thereof.

Of course, the overall height of the sealing element is configured, in comparison with the distance separating the first surface 331 of the peripheral area and the lower face 3 of the tray 4, to ensure a sealed support of the sealing element on this face 3. It is possible to tune the elasticity of the gaskets 31, 32, and in particular that of the gasket 32, so as to slightly deform the sealing element in compression in its housing under the tray 4.

Another portion of the second gasket 32 bears on the support 30, via a lower face of the latter. At this level, the support 30 advantageously has a three-dimensional shape forming an angle, opposite to the angle formed by the first and second surfaces 311, 312. Furthermore, a connection fillet 300 preferably connects the two sidewalls of this angle.

FIGS. 5A to 5C successively show the first gasket 31, the support 30 and the second gasket 32.

As indicated before with reference to FIGS. 1 and 2, it is advantageous, according to the invention, to perform a lateral injection of water into the receptacle 2a, 2b. In the configuration of FIG. 3, the water supply path towards the brewing chamber comprises a passage from an injector 25 (itself preferably connected to a portion further upstream of a hydraulic circuit which may include a pump, a boiler), up to the receptacle 2a, 2b passing through a space delimited by the external wall of the sleeve 20. The water supply circuit 26 then comprises an interstitial passage between the outer face 22 of the sleeve 20 and an inner face of the body 24, as shown in FIG. 4.

Downwards, the passage of water is prohibited by a gasket 23 sealing a support at this level between the outer face of the sleeve 20 and the inner wall of the body 24.

Conversely, while flowing upwards, water finds a passage 27 between the lower face 3 of the tray 4 and the distal end of the sleeve 20. The water paths formed by the portions 26 and 27 do not need to have a large volume. In particular, at least 1/10th of a millimetre of spacing between the distal end of the sleeve 20 and the lower face 3 of the tray 4 is enough; the same is true for the spacing between the outer face 22 of the sleeve 20 and the inner face of the body 24. Possibly, opposite the outlet of the injector 25, the circuit 26 may be wider, for example by forming a groove on the internal wall of the body 24.

At the peripheral area receiving the sealing element, the support 30 advantageously has a cylindrical shaped inner wall forming the internal surface of the sealing element and also forming a passage space between this internal surface and the external surface of the sleeve. The clearance enabling the passage of water may be within the same range as that indicated before.

Advantageously, the support 30 comes into contact neither with the lower face 3 of the tray 4 nor with the first surface 311 of the annular portion 33 forming the peripheral area. In this context, during the travel of the water, it should be understood that part of the water is introduced into the sealing element, at the level of the first gasket 32. The pressure of the water exerted at this level on the lower face of the support 30 preferably reinforces the application of the first gasket 31 on the lower face 3.

Like before, during brewing of beverages, water gradually descends inside the receptacle 2a, 2b from the passage 27 at the top of the sleeve. An outlet 28 in the plunger 10 ensures the evacuation of the brewed beverage.

Preferably, all of the operating cycles of the unit are automated so as to provide the user with optimum productivity and ease of use.

It should be understood that the cooperation by contact between the lower face 3 of the tray 4 and the sealing element is an essential aspect for proper operation. On the other hand, this cooperation could impact the movements of the tray 4. In particular, the friction under the tray 4 potentially induces a shift between a theoretical stop position of the tray, and an actual stop position. Such a shift could occur upon wearing of the gasket 31 or else according to the variations in the operating phase of the brewing chambers 1a, 1 b; in the last case, when a brewing is in progress in a chamber, the swelling of the cutting and the passage of water are likely to increase the friction on the tray 4. Thus, according to one aspect of the invention, a correction of the braking of the tray 4 is suggested to take account of these variations in friction on its lower face 3.

In this context, the unit advantageously is provided with presence sensors, and in particular the first sensor 37 and the second sensor 38 illustrated in FIG. 6. This figure shows the tray 4 in top view with an orifice 5 arranged equidistant from the mouths of the brewing chambers 1a and 1b. The latter are therefore closed by the tray 4 in this configuration, which may be called the rest configuration.

The sensors 37, 38 may implement different technologies, in particular optical or magnetic technologies.

FIG. 6 also reveals radial projections of the tray 4, for example in the form of legs, respectively a first leg 34, a second leg 35, and an intermediate leg 36. The intermediate leg 36 is advantageously located at equal angular distance from the other legs 34, 35. Moreover, this intermediate situation 36 is configured so that the leg 36 interacts with at least one of the first and second sensors 37, 38 during the rotational movement of the tray 4.

The radial projection formed by its legs defines, for each of them, lateral edges whose passage could be detected by the sensors 37, 38 upon rotation of the tray 4.

Preferably, the intermediate leg 36 is aligned with the orifice 5, forming a symmetrical system around this axis of alignment. Preferably, the brewing chambers and the other legs 34, 36 are positioned symmetrically around this axis.

Advantageously, the relative position of the legs and of the sensors is configured so that the first sensor 37 faces the first leg 34, and the second sensor 38 faces the second leg 35, in this rest position.

Thus, a first possible function of the sensors is then to confirm this rest condition.

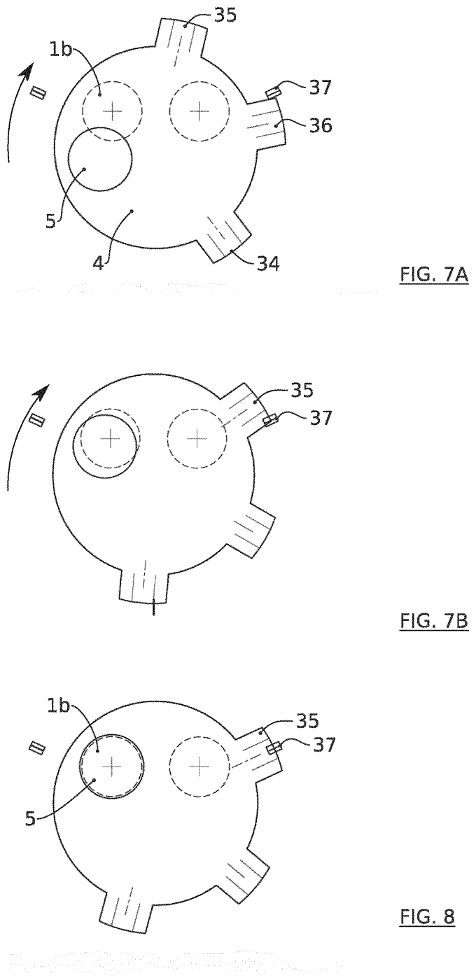

Upon a rotational movement of the tray 4, in particular to place the orifice 5 opposite the mouth of one of the brewing chambers, the relative position of the legs and of the sensors will be modified. In this context, FIGS. 7A, 7B and 8 illustrate three transitory intermediate positions of the tray 4 when the orifice 5 is directed towards the mouth of the brewing chamber 1b. This movement is a rotation oriented according to the arrows shown in FIGS. 7A and 7B. During this movement, the passage of the leg 36 in front of the first sensor 37 could be detected. For example, it is possible to detect the passage of the downstream edge of the leg 36 in front of the sensor 37 during this movement. This corresponds to the situation of FIG. 7A. From the viewpoint of the sensor 37, this passage is revealed by a falling edge of the detection signal that follows a rising edge corresponding to the passage of the upstream edge of the leg 36 in front of the sensor 37.

When the rotational movement continues, as shown in FIG. 7B, it is the second leg 35 which reaches the first sensor 37. In particular, it is possible to detect the upstream edge of the leg 35, a detection which is reflected by a rising edge of the detection signal of the sensor 37.

The angular shift between the legs (and in particular between the edges of the these) being known, the measurement of the time shift between the two successive events of FIGS. 7A and 7B allows determining a rotational speed. Or, said otherwise, the time shift reveals, to within a factor, the rotational speed of tray 4. Without seeking the rotational speed of the tray, this time shift may also reveal a deviation with respect to a set value of this shift. Thus, if the measured shift is greater than the set value, it is concluded that the rotational speed of the tray is lower than its theoretical speed. If the measured shift is less, the opposite conclusion is reached. If the shift is zero, this means that the actual speed of the tray corresponds to its theoretical speed.

FIG. 8 provides a representation of the end of the tray movement following this phase, the orifice 5 having been brought right opposite the mouth of the brewing chamber 1b.

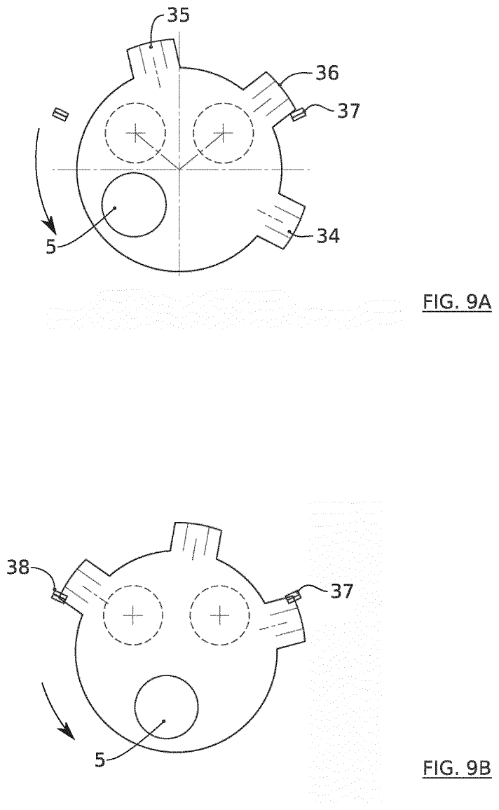

FIGS. 9A and 9B provide an example of a return movement, enabling the tray 4 to reach the rest position of FIG. 6. Similar to the previous case, FIG. 9A reveals the detection of a falling edge of the signal of the first sensor 37, when the downstream edge of the leg 36 passes in front of it. FIG. 9B reflects a detection of a rising edge of the signal when the upstream edge of the first leg 34 passes in front of the first sensor 37, and/or, when the upstream edge of the second leg 35 passes in front of the second sensor 38. Like before, the time shift between the events of FIGS. 9A and 9B could be determined. A conclusion on the rotational speed is then reached.

Thanks to this determination, the invention advantageously allows controlling the rotation system of the tray 4 to modulate braking thereof.

Preferably, the control system of the tray 4 also comprises an electronic module configured to apply an electric power signal to an electric drive motor of the tray. Advantageously, the electronic module further comprises data processing means, for example in the form of at least one processor, and data storage means, for example in the form of at least one memory, preferably comprising at least one non-transitory storage element. Preferably, a computer program product is stored in the non-transitory memory and comprises instructions for processing the previously-described time shift information and for defining a command to modify the electric power supply of the motor, according to this shift.

Thus, it is possible to regulate the braking of the motor according to the measurements taken. In this manner, the accuracy of positioning the tray (and in particular the orifice 5) with respect to the chambers is increased.

The invention is not limited to the previously-described embodiments and extends to all of the embodiments covered by the claims.

### LIST OF THE REFERENCES

1a, 1b. brewing chambers
2a, 2b. receptacles
3. internal face
4. movable tray
5. orifice
6. sealing gasket
7. water supply circuit
8. lateral wall
9. lower wall
10. plunger
11. motor drive of the plunger
12. solenoid valve
13. axis of rotation of the tray
14. motor drive of the tray
15. supply set
16. channel
17. funnel
18. lower end
19. mills
20. sleeve
21. inner face
22. outer face
23. gasket
24. body
25. injector
26. water supply circuit
27. passage
28. outlet
29. weight
30. support
31 first gasket
32. second gasket
33. annular portion
34. first leg
35. second leg
36. intermediate leg
37. first sensor
38. second sensor
301. groove
302. fillet
311. first surface
312. second surface
331. first surface
332. second surface

1. A unit for the preparation of beverages by brewing a dose of a product to be brewed, including at least one brewing chamber provided with a receptacle for the dose and with an injection circuit for injecting water into the receptacle, the brewing chamber being topped by a movable tray provided with an orifice adapted to be selectively placed opposite a mouth of the receptacle of the brewing chamber, so as to open or close the brewing chamber depending on the position of the orifice, the brewing chamber comprising a sealing element configured to ensure a sealed contact between a peripheral area of the mouth of the brewing chamber and a lower face of the tray, wherein it comprises a control system for controlling the tray configured to drive the tray in rotation and to determine a value reflecting the rotational speed of the tray.

2. The unit according to claim 1, wherein the control system is configured to assess a discrepancy between the determined value and a set value, and to modify the control of the tray according to the discrepancy.

3. The unit according to claim 2, wherein the control system is configured to determine a value reflecting the rotational speed of the tray by measuring a time shift between at least two predefined angular positions of the tray.

4. The unit according to claim 3, wherein the control system comprises at least one presence sensor and wherein the tray includes at least one area detectable by the sensor.

5. The unit according to claim 1, wherein the sealing element comprises:
a first gasket having a first surface bearing on the lower face of the tray;
a second gasket having a first surface bearing on the peripheral area; and
a support comprising an upper face bearing on a second surface of the first gasket and a lower face bearing on a second surface of the second gasket.

6. The unit according to claim 5, wherein the first surface of the first gasket is planar.

7. The unit according to claim 5, wherein the second gasket is an O-ring.

8. The unit according to claim 5, wherein the first surface of the second gasket is configured to be applied on the two surfaces of the peripheral area having different orientations.

9. The unit according to claim 5, wherein the upper face of the support includes a groove for mounting the first gasket.

10. The unit according to claim 5, wherein the lower face of the support includes an area in the form of a fillet.

11. The unit according to claim 1, wherein the brewing chamber comprises, at the mouth, an annular portion set back with respect to the wall of the receptacle, the setback annular portion for receiving the sealing element.

12. The unit according to claim 11, wherein the wall of the receptacle comprises a cylindrical sleeve, the setback annular portion being delimited by an outer face of the sleeve.

13. The unit according to claim 12, wherein the injection circuit comprises a water supply circuit, said water supply circuit comprising a portion extending along the outer face of the sleeve, up to a passage for supplying water into the receptacle.

14. The unit according to claim 13, wherein the passage comprises an interstitial space between an upper end of the sleeve and the lower face of the tray.

15. The unit according to claim 13, wherein the water supply circuit is formed between the outer face of the sleeve and an inner face of a body of the brewing chamber.

16. A beverage production machine, comprising at least one unit according to claim 1.
